(19) United States
(12) Patent Application Publication
(10) Pub. No.: US 2022/0341114 A1
(43) Pub. Date: Oct. 27, 2022

(54) MARINE DEBRIS COLLECTION DEVICE

(71) Applicant: YAMAHA HATSUDOKI KABUSHIKI KAISHA, Iwata-shi (JP)

(72) Inventors: Susumu SHIBAYAMA, Shizuoka (JP); Nobuharu OTA, Shizuoka (JP)

(21) Appl. No.: 17/859,157

(22) Filed: Jul. 7, 2022

Related U.S. Application Data
(63) Continuation of application No. PCT/JP2020/008102, filed on Feb. 27, 2020.

(51) Int. Cl. E02B 15/10; B63B 35/32

(52) U.S. Cl. CPC E02B 15/106; B63B 35/32; E02B 15/107

(57) ABSTRACT

A marine debris collection device includes a first debris collector to remove non-minute debris contained in debris floating on water by allowing the debris to flow thereinto together with the water, and a second debris collector to remove minute debris by adsorbing the minute debris onto a microbubble generated when the water flows into the second debris collector from the first debris collector via a connection pipe.

### CROSS REFERENCE TO RELATED APPLICATIONS

This application is a Continuation Application of PCT Application No. PCT/JP2020/008102 filed on Feb. 27, 2020. The entire contents of this application are hereby incorporated herein by reference.

### BACKGROUND OF THE INVENTION

### 1. Field of the Invention

The present invention relates to a marine debris collection device, and more particularly, it relates to a marine debris collection device that removes debris floating on the sea.

### 2. Description of the Related Art

A floating debris collection device that removes debris floating on the water surface is conventionally known, as disclosed in Japanese Utility Model Registration No. 3043270, for example.

Japanese Utility Model Registration No. 3043270 discloses a floating debris collection device including a net bag installed on a marine vessel. The floating debris collection device moves a marine vessel forward to take floating debris in the net bag and remove the floating debris.

However, the floating debris collection device disclosed in Japanese Utility Model Registration No. 3043270 disadvantageously removes only relatively large debris (non-minute debris) that is able to be caught by the net bag. Although not clearly described in Japanese Utility Model Registration No. 3043270, it is conventionally desired to remove small debris such as proteins that change into harmful substances in seawater.

### SUMMARY OF THE INVENTION

Preferred embodiments of the present invention provide marine debris collection devices that each remove both non-minute debris and minute debris.

A marine debris collection device according to a preferred embodiment of the present invention includes a first debris collector to remove non-minute debris contained in debris floating on a sea by allowing the debris to flow thereinto together with seawater and, a connection pipe including a first end connected to the first debris collector to drain the seawater from the first debris collector, and a second debris collector connected to a second end of the connection pipe to remove minute debris left unremoved by the first debris collector by adsorbing the minute debris onto a microbubble generated when the seawater flows into the second debris collector from the first debris collector via the connection pipe and floating the minute debris.

A marine debris collection device according to a preferred embodiment of the present invention includes the first debris collector to remove the non-minute debris contained in the debris floating on the sea by allowing the debris to flow thereinto together with seawater, and the second debris collector to remove the minute debris left unremoved by the first debris collector by adsorbing the minute debris onto the microbubble generated when the seawater flows into the second debris collector from the first debris collector via the connection pipe and floating the minute debris. Accordingly, the second debris collector further removes, using the microbubble, the minute debris from the seawater from which the non-minute debris has been removed by the first debris collector. That is, both the non-minute debris and the minute debris are removed by a single device (the marine debris collection device). Furthermore, the minute debris in the seawater such as microplastics and proteins that change into harmful substances in seawater (such as fish excrement and fish leftovers) is adsorbed onto the microbubble, and is removed. In this respect, it is effective to use the marine debris collection device in the sea.

In a marine debris collection device according to a preferred embodiment of the present invention, the second debris collector preferably includes an underwater bubble outlet to discharge, below the second end of the connection pipe, the microbubble into seawater outside the second debris collector. Accordingly, in addition to adsorbing the microbubble onto the minute debris and floating it with the second debris collector, the microbubble is discharged into the seawater via the underwater bubble outlet. Consequently, the second debris collector removes the minute debris and discharges the microbubble via the underwater bubble outlet to increase the amount of dissolved oxygen in the seawater. Thus, the amount of dissolved oxygen in the seawater is increased such that the growth of living organisms in the seawater (such as fish) is promoted, and thus in this respect as well, it is effective to use the marine debris collection device in the sea.

In such a case, the underwater bubble outlet is preferably provided in a vicinity of or adjacent to a lower end of the second debris collector. Accordingly, the microbubble is discharged into the seawater via the underwater bubble outlet at a relatively deep position in the vicinity of or adjacent to the lower end of the second debris collector, and thus a period of time during which the microbubble discharged via the underwater bubble outlet exists in the seawater is increased. Consequently, the amount of dissolved oxygen in the seawater is effectively increased, and thus the growth of living organisms in the seawater is further promoted.

In a marine debris collection device including the second debris collector that includes the underwater bubble outlet, the underwater bubble outlet is preferably located below a lower end of the first debris collector. Accordingly, as compared with a case in which the underwater bubble outlet is provided at the same height as or above the lower end of the first debris collector, a period of time during which the microbubble discharged via the underwater bubble outlet exists in the seawater is further increased. Consequently, the amount of dissolved oxygen in the seawater is further increased.

In a marine debris collection device according to a preferred embodiment of the present invention, the connection pipe preferably includes a flow path narrowed portion provided in a flow path of the connection pipe to narrow the flow path, and a first bubble generator connected to a vicinity (including the flow path narrowed portion itself) of the flow path narrowed portion to generate the microbubble by supplying air to the seawater that flows through the connection pipe. Accordingly, the microbubble is effectively generated by the first bubble generator in the flow path narrowed portion in which the flow path is narrowed and the flow velocity is increased. Furthermore, the microbubble is generated and adsorbed onto the minute debris before the minute debris flows into the second debris collector. That is, the microbubble is generated and adsorbed onto the minute debris in an early stage, and the minute debris is effectively removed.

In such a case, the second debris collector preferably includes a second bubble generator to generate the microbubble by providing an annular flow path in a plan view and generating swirling flows. Accordingly, the first bubble generator and the second bubble generator generate the microbubble in two stages, and thus a larger number of microbubbles are generated.

In a marine debris collection device including the second debris collector that includes the second bubble generator, the second bubble generator preferably includes the second end of the connection pipe connected to the second debris collector at a position deviated from a center position of the second debris collector in a right-left direction to allow the seawater to flow along the annular flow path inside the second debris collector. Accordingly, the seawater flows along the annular flow path such that the flow velocity is increased, and the swirling flows are more effectively generated. Thus, a larger number of microbubbles are generated.

In a marine debris collection device including the second debris collector that includes the conical portion, the second bubble generator preferably includes a conical portion having a conical shape that tapers upward from a vicinity of a lower end of the second debris collector. Accordingly, the conical portion easily defines the annular flow path to generate the swirling flows inside the second debris collector, and the lower flow path inside the second debris collector is narrowed, and thus an excessive increase in the number of microbubbles heading downward is significantly reduced or prevented.

In such a case, the second end of the connection pipe is preferably located at a height that overlaps the conical portion in the upward-downward direction. Accordingly, immediately after the seawater flows into the second debris collector from the second end of the connection pipe, the seawater flows along the annular flow path, and thus the swirling flows are more effectively generated. Consequently, a larger number of microbubbles are generated.

In a marine debris collection device including the connection pipe that includes the flow path narrowed portion and the first bubble generator, the flow path narrowed portion preferably includes a protrusion that protrudes into the flow path to narrow the flow path. Accordingly, in the flow path narrowed portion in which the flow velocity is increased, the protrusion disturbs the flow of the seawater to generate the microbubble more effectively.

In such a case, the protrusion preferably includes a curved surface that protrudes toward the first debris collector. Accordingly, the minute debris flows along the curved surface that protrudes toward the first debris collector (toward the upstream side in a direction in which the seawater flows), and thus the minute debris easily passes through the protrusion. Consequently, clogging of the protrusion with the minute debris is significantly reduced or prevented.

In a marine debris collection device including the protrusion that includes the curved surface, the protrusion preferably has an arcuate shape including the curved surface, and the first bubble generator preferably includes an end located in a vicinity of or adjacent to the protrusion and on an inner peripheral side of the protrusion in a plan view. Accordingly, the end of the first bubble generator is provided on the inner peripheral side of the protrusion, and thus the flow velocity of the seawater is decreased at a location at which air is introduced into the seawater by the first bubble generator. Consequently, the first bubble generator supplies a large amount of air to the connection pipe without being obstructed by the flow of the seawater.

A marine debris collection device according to a preferred embodiment of the present invention preferably further includes a submerged pump to generate a flow of the seawater that flows into the first debris collector and a flow of the seawater that flows into the second debris collector via the connection pipe. Accordingly, as compared with a case in which a dedicated submerged pump is provided for each of the first debris collector and the second debris collector, the device structure is simplified.

In such a case, the submerged pump is preferably installed in the first debris collector. Accordingly, the submerged pump installed in the first debris collector takes in the seawater before the microbubble is generated, and thus a decrease in the pump efficiency due to cavitation caused by the intake of the microbubble is prevented.

In a marine debris collection device including the submerged pump, the first debris collector preferably includes a cylindrical inner member including an opening at an upper end thereof to allow the seawater to flow into the cylindrical inner member, the cylindrical inner member having buoyancy so as to float, and an outer member maintained at a predetermined height with respect to the water surface, the outer member housing the submerged pump and the cylindrical inner member, and the cylindrical inner member preferably descends in the seawater such that the opening moves below the water surface when the submerged pump is driven, and ascends in the seawater such that the opening moves above the water surface when the submerged pump is stopped. Accordingly, when the submerged pump is driven, the inflow of the seawater and the debris is started, and when the submerged pump is stopped, the inflow of the seawater and the debris is terminated, and the opening of the inner member is moved above the water surface. Thus, leakage of the debris to the outside of the inner member is prevented.

In such a case, the cylindrical inner member preferably has the buoyancy due to an air reservoir integral and unitary with the cylindrical inner member, or has the buoyancy due to a float separate from the cylindrical inner member. Accordingly, when the inner member has buoyancy due to the air reservoir or the float, the opening of the inner member is easily moved above the water surface using the stoppage of the submerged pump as a trigger. Furthermore, the air reservoir is integral and unitary with the inner member, and thus the number of components is decreased while the device structure is simplified.

In a marine debris collection device including the second debris collector that includes the underwater bubble outlet, the first debris collector preferably allows the microbubble and the minute debris discharged via the underwater bubble outlet to flow thereinto together with seawater again. Accordingly, the minute debris is repeatedly removed, and thus the minute debris is reliably decreased.

In a marine debris collection device according to a preferred embodiment of the present invention, the second debris collector preferably includes a discharge pipe at an upper end thereof to discharge a floated microbubble onto which the minute debris has been adsorbed to the water surface, and the marine debris collection device preferably further includes a reservoir to store the microbubble discharged via the discharge pipe together with the minute debris. Accordingly, the removed minute debris is stored in the reservoir, and thus the minute debris is easily discarded.

In such a case, the reservoir preferably includes a defoaming agent to eliminate the microbubble stored in the reservoir. Accordingly, the overflow of the microbubble together with the minute debris due to continuous accumulation of the microbubble in the reservoir is significantly reduced or prevented.

A marine debris collection device according to a preferred embodiment of the present invention preferably further includes a bracket to fix the first debris collector and the second debris collector to a floating pier or the like that floats on the water surface. Accordingly, the bracket allows the first debris collector and the second debris collector to maintain their heights with respect to the water surface. That is, when the marine debris collection device is used in seawater, the first debris collector and the second debris collector are prevented from being located at heights at which they do not work (such as positions at which they are completely submerged) due to the influence of the ebb and flow of the tide.

According to various preferred embodiments of the present invention, as described above, it is possible to provide marine debris collection devices that each remove both non-minute debris and minute debris.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram schematically showing a marine debris collection device according to a preferred embodiment of the present invention.

FIG. 2 is a sectional view obliquely showing a first debris collection device of a marine debris collection device according to a preferred embodiment of the present invention.

FIG. 3 is a diagram illustrating the operation of a first debris collection device of a marine debris collection device according to a preferred embodiment of the present invention.

FIG. 4 is an enlarged view of a portion A in FIG. 1.

FIG. 5 is a sectional view taken along the line V-V in FIG. 4.

FIG. 6 is a sectional view obliquely showing a second debris collection device of a marine debris collection device according to a preferred embodiment of the present invention.

FIG. 7 is a sectional view taken along the line VII-VII in FIG. 6.

FIG. 8 is a sectional view taken along the line VIII-VIII in FIG. 6.

FIG. 9 is a diagram schematically showing a first debris collection device of a marine debris collection device according to a modified example.

### DETAILED DESCRIPTION OF THE PREFERRED EMBODIMENTS

Preferred embodiments of the present invention are hereinafter described on the basis of the drawings.

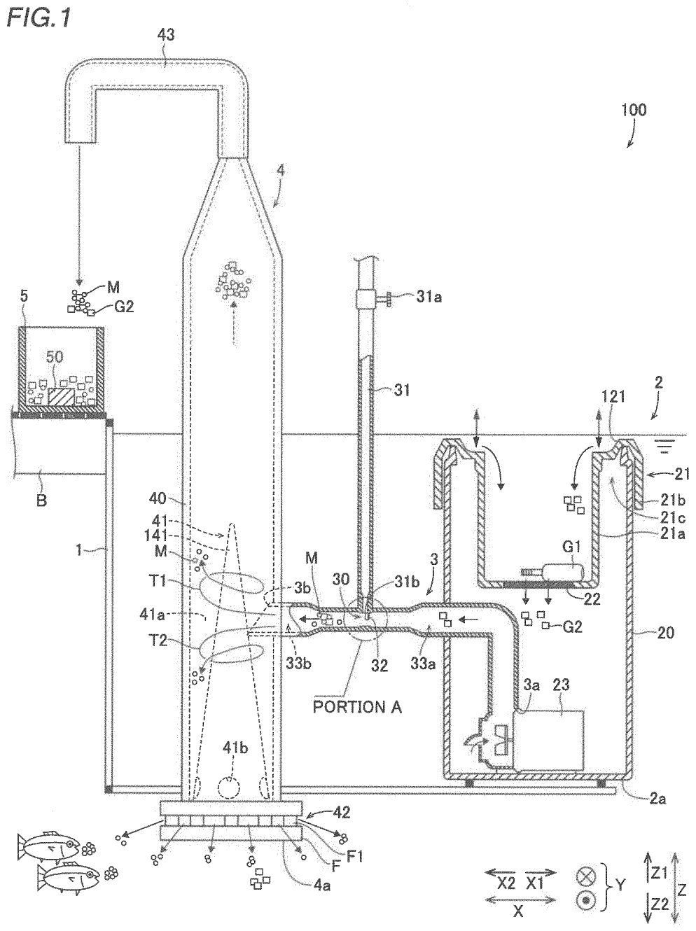

The structure of a marine debris collection device 100 according to preferred embodiments of the present invention is described with reference to FIGS. 1 to 8.

As shown in FIG. 1, the marine debris collection device 100 includes a bracket 1, a first debris collection device 2, a connection pipe 3, a second debris collection device 4, and a reservoir 5.

In the figures, a direction in which the first debris collection device 2 and the second debris collection device 4 are aligned is indicated by an X direction. In the X direction, a direction from the second debris collection device 4 toward the first debris collection device 2 is indicated by an X1 direction, and the opposite direction is indicated by an X2 direction.

Furthermore, an upward-downward direction is indicated by a Z direction, an upward direction is indicated by a Z1 direction, and a downward direction is indicated by a Z2 direction. A direction perpendicular to the X direction and the Z direction is indicated by a Y direction. The X direction and the Y direction are along a horizontal direction.

The marine debris collection device 100 collects and removes debris floating on the sea. Specifically, the marine debris collection device 100 removes (strains) relatively large debris (non-minute debris G1) floating on the sea with a net 22 described below of the first debris collection device 2, and removes relatively small debris (minute debris G2) left unremoved by the net 22 by adsorbing microbubbles M onto the relatively small debris with the second debris collection device 4 and floating or raising the relatively small debris.

The non-minute debris G1 refers to debris such as PET bottles, bottles, and bags, and the minute debris G2 refers to debris such as microplastics, fish excrement, and fish leftovers.

That is, the marine debris collection device 100 collects debris floating on the sea through two steps: a first step to remove relatively large debris (non-minute debris G1) and a second step to remove relatively small debris (minute debris G2) thereafter.

The marine debris collection device 100 discharges the microbubbles M into seawater with the second debris collection device 4 to promote the growth of living organisms. That is, the second debris collection device 4 uses the microbubbles M for two purposes to remove the minute debris G2 and to promote the growth of living organisms. The microbubbles M are generated when seawater flows from the first debris collection device 2 into the second debris collection device 4 via the connection pipe 3.

The microbubbles M refer to microbubbles having a bubble diameter of about 10 μm to about 100 μm at the time of generation. The microbubbles M have a high dissolution efficiency of gas (such as oxygen) and have a property of adsorbing pollutants. Furthermore, the microbubbles M have a property that the rise velocity in a liquid is very small (1 to 100 mm/min) and the surface area per unit gas amount is large. The structure of each portion of the marine debris collection device 100 is described in order below.

The bracket 1 fixes the first debris collection device 2 and the second debris collection device 4 to a floating pier B, or the like. The floating pier B is a structure installed while floating on the sea, and maintains its height with respect to the water surface according to the rise and fall of the water surface (the ebb and flow of the tide). As an example, the bracket 1 includes a support beam to support the first debris collection device 2 and the second debris collection device 4, and a fixing beam to fix the support beam to the floating pier B.

Therefore, the first debris collection device 2 and the second debris collection device 4, which are fixed to the floating pier B by the bracket 1, also move together with the floating pier B according to the rise and fall of the water surface (the ebb and flow of the tide) to maintain their heights with respect to the water surface.

The first debris collection device 2 allows debris floating on the sea to flow thereinto together with seawater and removes relatively large debris (non-minute debris G1) contained in the debris.

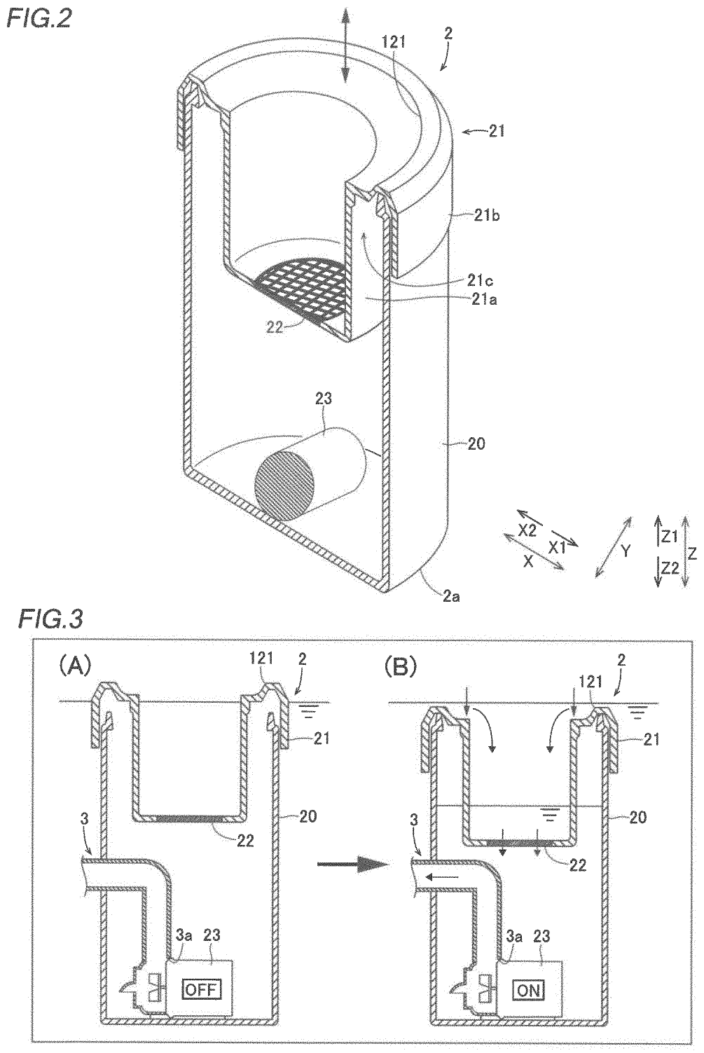

As shown in FIG. 2, the first debris collection device 2 includes an outer member (housing) 20, an inner member 21, the net 22, and a submerged pump 23.

The outer member 20 is directly supported by the bracket 1 (see FIG. 1) and is maintained at a predetermined height with respect to the water surface. The upper end of the outer member 20 is located below the water surface. The outer member 20 is a hollow cylindrical container including an open upper end and a closed lower end and extending in the upward-downward direction. The outer member 20 houses the submerged pump 23 and the inner member 21.

The inner member 21 is supported by the upper end of the outer member 20. The inner member 21 integrally includes a tubular portion 21a, a curved edge 21b provided at the upper end of the tubular portion 21a, and an air reservoir 21c, and has or receives buoyancy from the air reservoir 21c to float with respect to the outer member 20.

The tubular portion 21a has a cylindrical shape including a through-hole that penetrates in the upward-downward direction. The tubular portion 21a has a diameter slightly smaller than that of the outer member 20, and is provided inside the outer member 20. The tubular portion 21a includes an opening 121 at its upper end to allow seawater to flow thereinto. The net 22 is installed at the lower end of the tubular portion 21a, and the tubular portion 21a removes relatively large debris (non-minute debris G1) and allows relatively small debris (minute debris G2) to pass through the net 22 when seawater passes through the tubular portion 21a. The relatively large debris (non-minute debris G1) that has not passed through the net 22 is accumulated inside the inner member 21.

The edge 21b horizontally extends in an outer peripheral direction from the upper end of the tubular portion 21a, further extends downward from the outer peripheral end, and covers an upper portion of the outer member 20.

The air reservoir 21c is an annular space between the tubular portion 21a and the edge 21b. The air reservoir 21c is surrounded by the tubular portion 21a and the edge 21b such that water does not enter the air reservoir 21c. Therefore, the air reservoir 21c constantly provides buoyancy to the inner member 21.

When the submerged pump 23 is driven, the inner member 21 descends in the seawater, and the opening 121 moves below the water surface. Consequently, the inner member 21 (first debris collection device 2) allows seawater to flow thereinto.

When the submerged pump 23 is stopped, the inner member 21 ascends in the seawater, and the opening 121 moves above the water surface. Consequently, the inner member 21 (first debris collection device 2) stops the flow of seawater thereinto. In such a case, the relatively large debris (non-minute debris G1) inside the inner member 21 is confined inside the inner member 21 and does not leak to the outside.

As shown in FIG. 1, the submerged pump 23 generates a flow of seawater that flows into the first debris collection device 2 and a flow of seawater that flows into the second debris collection device 4 via the connection pipe 3.

Specifically, the submerged pump 23 is installed at the inner lower end of the outer member 20 (first debris collection device 2). That is, the submerged pump 23 is provided directly below the inner member 21. A discharge port of the submerged pump 23 is connected to a first end 3a of the connection pipe 3. The submerged pump 23 takes in seawater stored inside the outer member 20 by rotating an impeller with a motor and sends the seawater to the second debris collection device 4 via the connection pipe 3.

The operation of the first debris collection device 2 is now described with reference to FIGS. 3A and 3B.

As shown in FIG. 3A, it is assumed that the submerged pump 23 is stopped. In this state, the opening 121 of the inner member 21 is located above the water surface. Furthermore, in this state, the water level inside the first debris collection device 2 (outer member 20) is substantially the same as the water level outside the first debris collection device 2 (outer member 20).

As shown in FIG. 3B, when the submerged pump 23 starts to be driven, the water level inside the first debris collection device 2 (outer member 20) drops. Along with this, the inner member 21 moves downward. Consequently, the opening 121 of the inner member 21 moves below the water surface.

Then, seawater starts to flow into the inner member 21 via the opening 121. Consequently, debris floating in the seawater is also taken in via the opening 121 of the inner member 21.

Then, relatively large debris (non-minute debris G1) that has not passed through the net 22 is accumulated inside the inner member 21. On the other hand, relatively small debris (minute debris G2) that has passed through the net 22 is sent together with the seawater to the second debris collection device 4 (see FIG. 1) via the connection pipe 3 (see FIG. 1) by the submerged pump 23.

When the submerged pump 23 stops being driven, the water level inside the first debris collection device 2 (outer member 20) rises. Along with this, the inner member 21 moves upward. Consequently, the opening 121 of the inner member 21 moves above the water surface, and the relatively large debris (non-minute debris G1) inside the inner member 21 is confined inside the inner member 21.

As shown in FIG. 1, the first end 3a of the connection pipe 3 is connected to the first debris collection device 2, and a second end 3b of the connection pipe 3 is connected to the second debris collection device 4. That is, the connection pipe 3 is a pipe conduit that connects the first debris collection device 2 to the second debris collection device 4. The connection pipe 3 extends substantially horizontally. That is, the connection pipe 3 allows seawater flowing substantially horizontally to flow into the second debris collection device 4.

The connection pipe 3 includes a decreased diameter portion 30, a first bubble generator 31, and a protrusion 32. The decreased diameter portion 30 and the protrusion 32 are examples of a “flow path narrowed portion”.

The decreased diameter portion 30 is located in the flow path, and the flow path diameter of the decreased diameter portion 30 is decreased (squeezed) as compared with other portions of the connection pipe 3. The diameter of the connection pipe 3 has a predetermined size such that the connection pipe 3 is not clogged with relatively small debris (minute debris G2). As an example, the diameter of the connection pipe 3 is about 5 mm or more and about 10 mm or less. Therefore, the decreased diameter portion 30 increases the flow velocity of the passing seawater. Furthermore, the decreased diameter portion 30 is a flow path extending linearly.

The flow path diameter of the connection pipe 3 is gradually decreased even in an upstream portion 33a (a portion of the first debris collection device 2) upstream of the decreased diameter portion 30. In contrast, the flow path diameter of the connection pipe 3 is gradually increased in a downstream portion 33b (a portion of the second debris collection device 4) downstream of the decreased diameter portion 30.

The first bubble generator 31 is connected to the flow path (decreased diameter portion 30), and generates the microbubbles M in the seawater sent to the second debris collection device 4 by supplying air from the water surface to the seawater flowing through the connection pipe 3 and having an increased flow velocity.

That is, the first bubble generator 31 generates the microbubbles M in the seawater that has exited the decreased diameter portion 30 by supplying air to the seawater immediately before the seawater exits the decreased diameter portion 30 and the flow path diameter of the connection pipe 3 is increased.

The relatively small debris (minute debris G2) contained in the seawater is adsorbed onto the microbubbles M generated in the first bubble generator 31. The first bubble generator 31 includes an adjustment valve 31a to adjust the amount of supplied air.

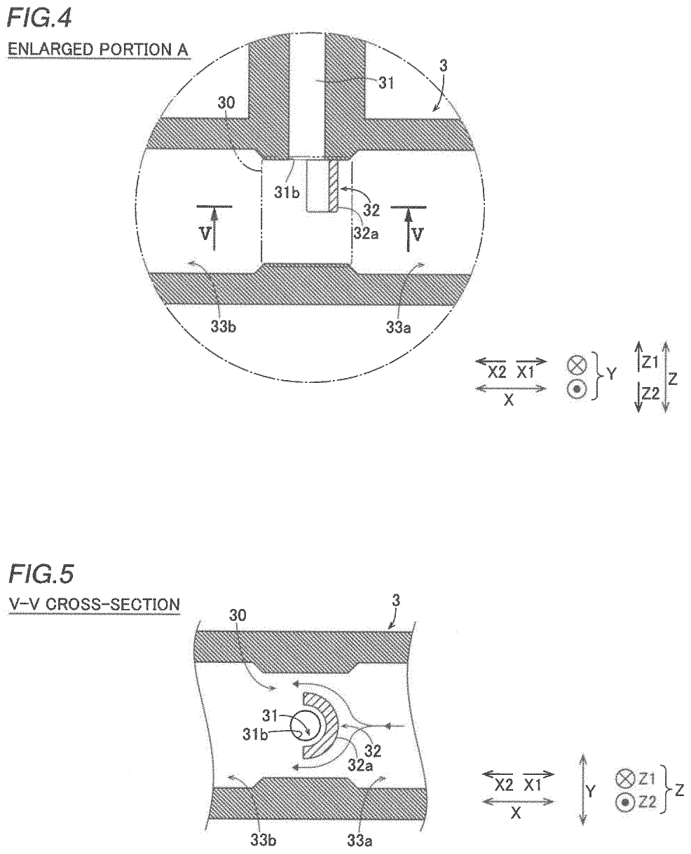

As shown in FIGS. 4 and 5, the protrusion 32 protrudes into the flow path in the decreased diameter portion 30 to narrow the flow path. The protrusion 32 protrudes from the upper side to the lower side. The lower end of the protrusion 32 is located in the vicinity of or adjacent to the center of the decreased diameter portion 30 in the upward-downward direction.

The protrusion 32 includes a curved surface 32a protruding toward the first debris collection device 2. Specifically, the protrusion 32 has an arcuate shape including the curved surface 32a and a thin wall shape. In a plan view, a connecting portion 31b (an opening at the lower end of the first bubble generator 31) between the first bubble generator 31 and the decreased diameter portion 30 is located on the inner peripheral side of the protrusion 32. The connecting portion 31b is an example of an “end of the first bubble generator located in a vicinity of or adjacent to the protrusion”.

Therefore, the air from the first bubble generator 31 is supplied to a position covered by the curved protrusion 32 immediately after passing through the connecting portion 31b between the first bubble generator 31 and the decreased diameter portion 30. That is, the air from the first bubble generator 31 is supplied to a position in the decreased diameter portion 30 at which the flow velocity is relatively low immediately after passing through the connecting portion 31b between the first bubble generator 31 and the decreased diameter portion 30.

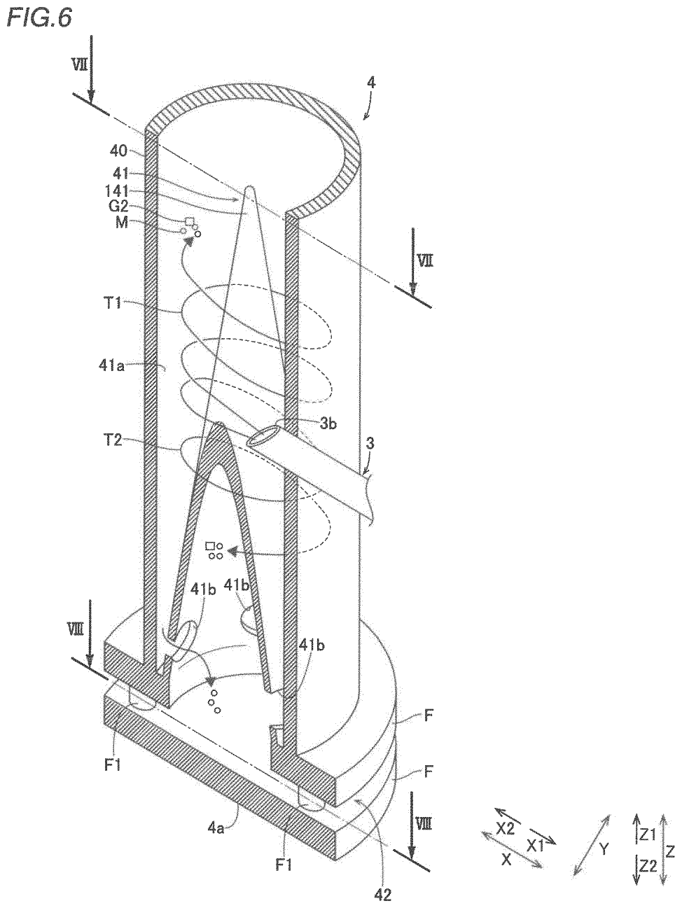

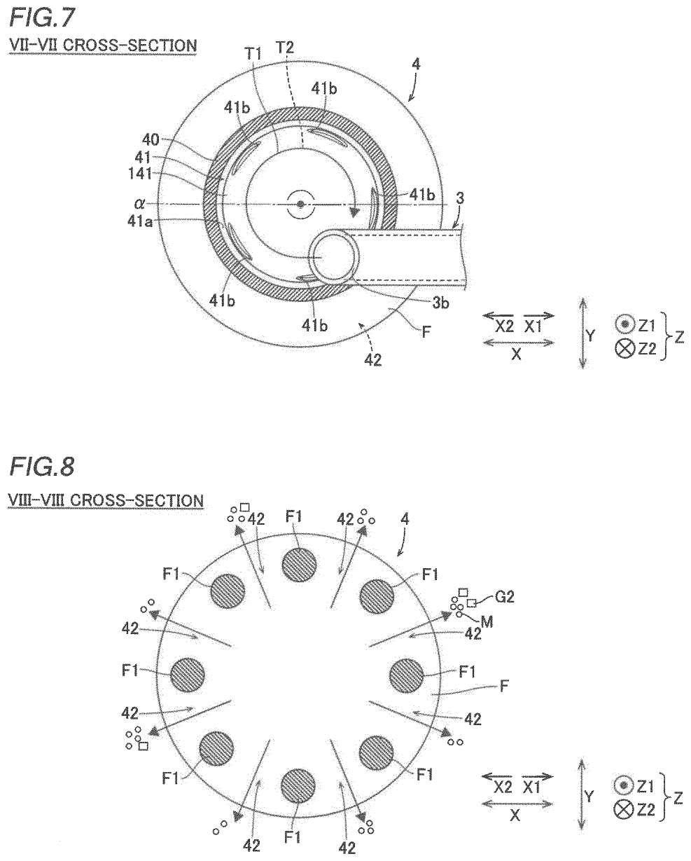

As shown in FIG. 6, the second end 3b of the connection pipe 3 is connected to the second debris collection device 4 at a position deviated from the center position a (see FIG. 7) of the second debris collection device 4 in a right-left direction (Y direction), and allows the seawater to flow along an annular flow path 41a inside the second debris collection device 4. The annular flow path 41a is provided by a second bubble generator 41 (conical portion 141) described below of the second debris collection device 4.

The seawater flows along the annular flow path 41a such that swirling flows T1 and T2 generated inside the second debris collection device 4 by the second bubble generator 41 are enhanced, and the microbubbles M are effectively generated.

The second end 3b of the connection pipe 3 is located at a height that overlaps the conical second bubble generator 41 in the upward-downward direction. Specifically, the second end 3b of the connection pipe 3 is located below the upper end of the second bubble generator 41 and above the lower end of the second bubble generator 41.

The second end 3b of the connection pipe 3 is cut obliquely such that a lower portion of the second end 3b is located more inward of the second debris collection device 4 than an upper portion of the second end 3b. That is, the second end 3b of the connection pipe 3 has an upwardly open shape such that the seawater supplied to the second debris collection device 4 and the microbubbles M easily head upward.

As shown in FIG. 6, the second debris collection device 4 removes the minute debris G2 by adsorbing the minute debris G2 left unremoved by the first debris collection device 2 onto the microbubbles M generated when the seawater flows into the second debris collection device 4 from the first debris collection device 2 via the connection pipe 3 and raising or floating the minute debris G2.

The second debris collection device 4 includes a housing 40, the second bubble generator 41, an underwater bubble outlet 42 located in the vicinity of or adjacent to the lower end of the second debris collection device 4, and a discharge pipe 43 provided at the upper end of the second debris collection device 4. The second bubble generator 41 includes the conical portion 141 and the second end 3b of the connection pipe 3.

The housing 40 is directly supported by the bracket 1 (see FIG. 1) and is maintained at a predetermined height with respect to the water surface. The housing 40 is a hollow cylindrical container that extends in the upward-downward direction. The housing 40 houses the conical portion 141. The upper end of the housing 40 is located above the water surface and above the upper end of the first debris collection device 2. The lower end 4a of the housing 40 is located below the lower end 2a of the first debris collection device 2.

The conical portion 141 generates the microbubbles M by providing the annular flow path 41a in a plan view and generating the swirling flows T1 and T2 in the housing 40. Relatively small debris (minute debris G2) is adsorbed onto the microbubbles M generated by the conical portion 141. In the housing 40, two swirling flows are generated: a swirling flow T1 heading upward (toward the discharge pipe 43) and a swirling flow T2 heading downward (toward the underwater bubble outlet 42). Therefore, the microbubbles M onto which the relatively small debris (minute debris G2) has been adsorbed rise together with the swirling flow T1, and a portion of the microbubbles M flows downward together with the swirling flow T2 and is discharged via the underwater bubble outlet 42.

The conical portion 141 has a hollow conical shape that tapers upward from the vicinity of the lower end of the second debris collection device 4. Therefore, the annular flow path 41a is provided between the conical portion 141 and the housing 40.

A plurality of (five, for example) through-holes 41b that communicate the inside with the outside of the conical portion 141 are located in the vicinity of or adjacent to the lower end of the hollow conical portion 141. The plurality of through-holes 41b are provided at equal or substantially equal angular intervals in the circumferential direction of the conical portion 141.

The microbubbles M that flow downward together with the swirling flow T2 flow into the conical portion 141 via the through-holes 41b. Then, the microbubbles M are discharged via the underwater bubble outlet 42 below the conical portion 141.

The underwater bubble outlet 42 discharges, below the second end 3b of the connection pipe 3, the microbubbles M into the seawater outside the second debris collection device 4. The underwater bubble outlet 42 is located below the lower end 2a (see FIG. 1) of the first debris collection device 2.

The underwater bubble outlet 42 is provided at the lower end of the housing 40 and is defined by a gap between a pair of flanges F that face each other in the upward-downward direction. The pair of flanges F are connected to each other by a plurality of columnar connectors F1 that extend in the upward-downward direction. The plurality of connectors F1 are annularly provided at equal or substantially equal angular intervals in a plan view.

The microbubbles M that flow downward together with the swirling flow T2 are radially distributed in a plan view through gaps between the through-holes 41b and the plurality of connectors F1 and are discharged into the seawater (see FIG. 8). The plurality of connectors F1 are provided on the outer peripheral side of a region directly below an internal space of the hollow conical portion 141 to not obstruct the flow of the seawater.

The first debris collection device 2 shown in FIG. 1 allows the microbubbles M and the minute debris G2 discharged via the underwater bubble outlet 42 to flow thereinto together with the seawater again. Thus, the marine debris collection device 100 decreases not only the non-minute debris G1 but also the total amount of minute debris G2 by repeatedly collecting and removing the debris. The microbubbles M discharged via the underwater bubble outlet 42 contribute to the promotion of the growth of living organisms.

The discharge pipe 43 discharges the floated or raised microbubbles M onto which the minute debris G2 has been adsorbed to the reservoir 5 provided on the water surface. The discharge pipe 43 is installed on an upper portion of the housing 40.

The reservoir 5 is a container that stores the minute debris G2 adsorbed onto the microbubbles M. The reservoir 5 includes a defoaming agent 50 that eliminates the microbubbles M stored in the reservoir 5. Thus, the overflow of the microbubbles M from the reservoir 5 is significantly reduced or prevented. As an example, the defoaming agent 50 is a solid material, and is located in the reservoir 5 while being suspended from above by a string, for example. In addition to this, the microbubbles M may be eliminated using an ultrasonic generator, for example.

The operation of the marine debris collection device 100 is described with reference to FIG. 1.

First, the floating debris flows into the first debris collection device 2 together with seawater when the submerged pump 23 starts to be driven. Then, the non-minute debris G1 is removed by the first debris collection device 2. The minute debris G2 that has not been removed in the first debris collection device 2 is sequentially sent to the connection pipe 3 and the second debris collection device 4 together with the seawater.

In the connection pipe 3, the microbubbles M are generated by the first bubble generator 31, and a portion of the minute debris G2 is adsorbed onto the microbubbles M and flows into the second debris collection device 4.

In the second debris collection device 4, the microbubbles M are further generated by the swirling flows T1 and T2 generated by the second bubble generator, and the minute debris G2 is further adsorbed onto the microbubbles M and rises. Then, the minute debris G2 is discharged from the discharge pipe 43 and stored in the reservoir 5.

In the second debris collection device 4, a portion (or most) of the microbubbles M is discharged into the seawater via the lower underwater bubble outlet. Consequently, it improves the amount of dissolved oxygen in the seawater and contributes to the growth of living organisms.

According to the various preferred embodiments of the present invention described above, the following advantageous effects are achieved.

According to a preferred embodiment of the present invention, the marine debris collection device 100 includes the first debris collection device 2 to remove the non-minute debris G1 contained in the debris floating on the sea by allowing the debris to flow thereinto together with seawater, and the second debris collection device 4 to remove the minute debris G2 left unremoved by the first debris collection device 2 by adsorbing the minute debris G2 onto the microbubbles M generated when the seawater flows into the second debris collection device 4 from the first debris collection device 2 via the connection pipe 3 and raising or floating the minute debris G2. Accordingly, the second debris collection device 4 further removes, using the microbubbles M, the minute debris G2 from the seawater from which the non-minute debris G1 has been removed by the first debris collection device 2. That is, both the non-minute debris G1 and the minute debris G2 are removed by a single device (the marine debris collection device 100). Furthermore, the minute debris G2 in the seawater such as microplastics and proteins that change into harmful substances in seawater (such as fish excrement and fish leftovers) is adsorbed onto the microbubbles M, and is removed. In this respect, it is effective to use the marine debris collection device 100 in the sea.

According to a preferred embodiment of the present invention, the second debris collection device 4 includes the underwater bubble outlet 42 to discharge, below the second end 3b of the connection pipe 3, the microbubbles M into seawater outside the second debris collection device 4. Accordingly, in addition to adsorbing the microbubbles M onto the minute debris G2 and raising or floating them with the second debris collection device 4, the microbubbles M are discharged into seawater via the underwater bubble outlet 42. Consequently, the second debris collection device 4 removes the minute debris G2 and discharges the microbubbles M via the underwater bubble outlet 42 to increase the amount of dissolved oxygen in seawater. Thus, the amount of dissolved oxygen in seawater is increased such that the growth of living organisms in seawater (such as fish) is promoted, and thus in this respect as well, it is effective to use the marine debris collection device 100 in the sea.

According to a preferred embodiment of the present invention, the underwater bubble outlet 42 is located in the vicinity of or adjacent to the lower end 4a of the second debris collection device 4. Accordingly, the microbubbles M are discharged into seawater via the underwater bubble outlet 42 at a relatively deep position in the vicinity of or adjacent to the lower end 4a of the second debris collection device 4, and thus a period of time during which the microbubbles M discharged via the underwater bubble outlet 42 exist in the seawater is increased. Consequently, the amount of dissolved oxygen in the seawater is effectively increased, and thus the growth of living organisms in the seawater is further promoted.

According to a preferred embodiment of the present invention, the underwater bubble outlet 42 is located below the lower end 2a of the first debris collection device 2. Accordingly, as compared with a case in which the underwater bubble outlet 42 is provided at the same height as or above the lower end 2a of the first debris collection device 2, a period of time during which the microbubbles M discharged via the underwater bubble outlet 42 exist in the seawater is further increased. Consequently, the amount of dissolved oxygen in the seawater is further increased.

According to a preferred embodiment of the present invention, the connection pipe 3 includes the flow path narrowed portion (the decreased diameter portion 30 and the protrusion 32) located in the flow path to narrow the flow path, and the first bubble generator 31 connected to the vicinity (including the flow path narrowed portion itself) of the flow path narrowed portion to generate the microbubbles M by supplying air to the seawater that flows through the connection pipe 3. Accordingly, the microbubbles M are effectively generated by the first bubble generator 31 in the flow path narrowed portion (the decreased diameter portion 30 and the protrusion 32) in which the flow path is narrowed and the flow velocity is increased. Furthermore, the microbubbles M are generated and adsorbed onto the minute debris G2 before the minute debris G2 flows into the second debris collection device 4. That is, the microbubbles M are generated and adsorbed onto the minute debris G2 in an early stage, and the minute debris G2 is effectively removed.

According to a preferred embodiment of the present invention, the second debris collection device 4 includes the second bubble generator 41 to generate the microbubbles M by providing the annular flow path 41a in a plan view and generating the swirling flows T1 and T2. Accordingly, the first bubble generator 31 and the second bubble generator 41 generate the microbubbles M in two stages, and thus a larger number of microbubbles M are generated.

According to a preferred embodiment of the present invention, the second bubble generator 41 includes the second end 3b of the connection pipe 3 connected to the second debris collection device 4 at the position deviated from the center position a of the second debris collection device 4 in the right-left direction to allow the seawater to flow along the annular flow path 41a inside the second debris collection device 4. Accordingly, the seawater flows along the annular flow path 41a such that the flow velocity is increased, and the swirling flows T1 and T2 are more effectively generated. Thus, a larger number of microbubbles M are generated.

According to a preferred embodiment of the present invention, the second bubble generator 41 includes the conical portion 141 having a conical shape that tapers upward from the vicinity of the lower end 4a of the second debris collection device 4. Accordingly, the conical portion 141 easily defines the annular flow path 41a to generate the swirling flows T1 and T2 inside the second debris collection device 4, and the lower flow path inside the second debris collection device 4 is narrowed, and thus an excessive increase in the number of microbubbles M heading downward is significantly reduced or prevented.

According to a preferred embodiment of the present invention, the second end 3b of the connection pipe 3 is provided at the height that overlaps the conical portion 141 in the upward-downward direction. Accordingly, immediately after the seawater flows into the second debris collection device 4 from the second end 3b of the connection pipe 3, the seawater flows along the annular flow path 41a, and thus the swirling flows T1 and T2 are more effectively generated. Consequently, a larger number of microbubbles M are generated.

According to a preferred embodiment of the present invention, the connection pipe 3 (flow path narrowed portion) includes the protrusion 32 that protrudes into the flow path to narrow the flow path. Accordingly, in the connection pipe 3 (flow path narrowed portion) in which the flow velocity is increased, the protrusion 32 disturbs the flow of the seawater to generate the microbubbles M more effectively.

According to a preferred embodiment of the present invention, the protrusion 32 includes the curved surface 32a that protrudes toward the first debris collection device 2. Accordingly, the minute debris G2 flows along the curved surface 32a that protrudes toward the first debris collection device 2 (toward the upstream side in a direction in which the seawater flows), and thus the minute debris G2 easily passes through the protrusion 32. Consequently, clogging of the protrusion 32 with the minute debris G2 is significantly reduced or prevented.

According to a preferred embodiment of the present invention, the protrusion 32 has an arcuate shape including the curved surface 32a, and the end (connecting portion 31b) of the first bubble generator 31 located in the vicinity of or adjacent to the protrusion 32 is provided on the inner peripheral side of the protrusion 32 in a plan view. Accordingly, the end (connecting portion 31b) of the first bubble generator 31 is provided on the inner peripheral side of the protrusion 32, and thus the flow velocity of the seawater is decreased at a position at which air is introduced into the seawater by the first bubble generator 31. Consequently, the first bubble generator 31 supplies a large amount of air to the connection pipe 3 without being obstructed by the flow of the seawater.

According to a preferred embodiment of the present invention, the marine debris collection device 100 further includes the submerged pump 23 to generate the flow of the seawater that flows into the first debris collection device 2 and the flow of the seawater that flows into the second debris collection device 4 via the connection pipe 3. Accordingly, as compared with a case in which a dedicated submerged pump 23 is provided for each of the first debris collection device 2 and the second debris collection device 4, the device structure is simplified.

According to a preferred embodiment of the present invention, the submerged pump 23 is installed in the first debris collection device 2. Accordingly, the submerged pump 23 installed in the first debris collection device 2 takes in the seawater before the microbubbles M are generated, and thus a decrease in the pump efficiency due to cavitation caused by the intake of the microbubbles M is prevented.

According to a preferred embodiment of the present invention, the first debris collection device 2 includes the cylindrical inner member 21 including the opening 121 at the upper end to allow seawater to flow into the cylindrical inner member 21 and floats due to its buoyancy, and the outer member 20 maintained at the predetermined height with respect to the water surface and housing the submerged pump 23 and the inner member 21. Furthermore, the inner member 21 descends in the seawater such that the opening 121 moves below the water surface when the submerged pump 23 is driven, and ascends in the seawater such that the opening 121 moves above the water surface when the submerged pump 23 is stopped. Accordingly, when the submerged pump 23 is driven, the inflow of the seawater and the debris is started, and when the submerged pump 23 is stopped, the inflow of the seawater and the debris is terminated, and the opening 121 of the inner member 21 is moved above the water surface. Thus, leakage of the debris to the outside of the inner member 21 is prevented.

According to a preferred embodiment of the present invention, the inner member 21 has buoyancy due to the air reservoir 21c integral and unitary with the inner member 21. Accordingly, when the inner member 21 has buoyancy due to the air reservoir 21c, the opening 121 of the inner member 21 is easily moved above the water surface using the stoppage of the submerged pump 23 as a trigger. Furthermore, the air reservoir 21c is integral and unitary with the inner member 21, and thus the number of components is decreased while the device structure is simplified.

According to a preferred embodiment of the present invention, the first debris collection device 2 allows the microbubbles M and the minute debris G2 discharged via the underwater bubble outlet 42 to flow thereinto together with seawater again. Accordingly, the minute debris G2 is repeatedly removed, and thus the minute debris G2 is reliably decreased.

According to a preferred embodiment of the present invention, the second debris collection device 4 includes the discharge pipe 43 at the upper end thereof to discharge the floated or raised microbubbles M onto which the minute debris G2 has been adsorbed to the water surface, and the marine debris collection device 100 further includes the reservoir 5 to store the microbubbles M discharged via the discharge pipe 43 together with the minute debris G2. Accordingly, the removed minute debris G2 is stored in the reservoir 5, and thus the minute debris G2 is easily discarded.

According to a preferred embodiment of the present invention, the reservoir 5 includes the defoaming agent 50 to eliminate the microbubbles M stored in the reservoir 5. Accordingly, the overflow of the microbubbles M together with the minute debris G2 due to continuous accumulation of the microbubbles M in the reservoir 5 is significantly reduced or prevented.

According to a preferred embodiment of the present invention, the marine debris collection device 100 further includes the bracket 1 to fix the first debris collection device 2 and the second debris collection device 4 to the floating pier B that floats on the water surface. Accordingly, the bracket 1 allows the first debris collection device 2 and the second debris collection device 4 to maintain their heights with respect to the water surface. That is, when the marine debris collection device 100 is used in seawater, the first debris collection device 2 and the second debris collection device 4 are prevented from being located at heights at which they do not work (such as positions at which they are completely submerged) due to the influence of the ebb and flow of the tide.

The preferred embodiments of the present invention described above are illustrative in all points and not restrictive. The extent of the present invention is not defined by the above description of the preferred embodiments but by the scope of the claims, and all modifications within the meaning and range equivalent to the scope of the claims are further included.

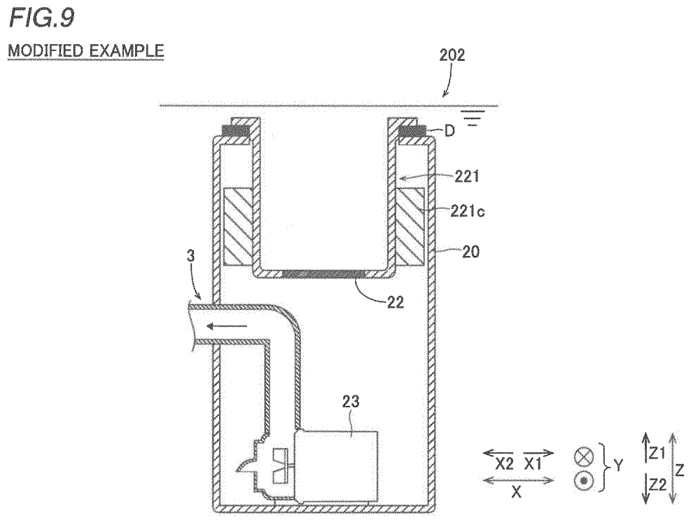

For example, while the inner member of the first debris collection device preferably has buoyancy due to the air reservoir integral and unitary with the inner member in preferred embodiments described above, the present invention is not restricted to this. In the present invention, as in a modified example shown in FIG. 9, an inner member 221 of a first debris collection device 202 may alternatively have buoyancy due to a float 221c separate from the inner member 221. In such a case, an elastic member D made of rubber or sponge, for example, is installed between the inner member 221 and an outer member 20 in order to prevent the ingress of water therebetween.

While the first bubble generator and the second bubble generator preferably generate the microbubbles in two stages in preferred embodiments described above, the present invention is not restricted to this. In the present invention, the microbubbles may alternatively be generated in one stage or three or more stages.

While the first debris collection device and the second debris collection device are preferably fixed to the floating pier in preferred embodiments described above, the present invention is not restricted to this. In the present invention, the first debris collection device and the second debris collection device may alternatively be fixed to a floating structure such as a marine vessel.

While only one submerged pump is preferably provided in preferred embodiments described above, the present invention is not restricted to this. In the present invention, a plurality of submerged pumps may alternatively be provided.

While the submerged pump is preferably installed in the first debris collection device in preferred embodiments described above, the present invention is not restricted to this. In the present invention, the submerged pump may alternatively be installed in the second debris collection device or the connection pipe.

While the inner member is preferably moved in the upward-downward direction when the submerged pump is driven in preferred embodiments described above, the present invention is not restricted to this. In the present invention, the inner member may alternatively be moved in the upward-downward direction by a dedicated structure different from the submerged pump.

While the microbubbles are preferably generated by supplying air to the decreased diameter portion and generating the swirling flows in preferred embodiments described above, the present invention is not restricted to this. In the present invention, the microbubbles may alternatively be generated by a method different from preferred embodiments described above, such as using a wood stone.

While the flow path narrowed portion preferably includes the decreased diameter portion to decrease the flow path diameter (inner diameter) itself, and the protrusion that protrudes into the flow path in preferred embodiments described above, the present invention is not restricted to this. In the present invention, the flow path narrowed portion may alternatively include only one of the decreased diameter portion and the protrusion.

While the second debris collection device preferably includes the underwater bubble outlet in preferred embodiments described above, the present invention is not restricted to this. In the present invention, the second debris collection device may not include the underwater bubble outlet.

While the second bubble generator preferably has a conical shape in preferred embodiments described above, the present invention is not restricted to this. In the present invention, the second bubble generator may alternatively have a shape different from the conical shape such as a cylindrical shape or a polygonal pyramid shape as long as swirling flows are generated by the second bubble generator.

While air is preferably supplied directly to the connection pipe in preferred embodiments described above, the present invention is not restricted to this. In the present invention, air may alternatively be supplied directly to the first debris collection device or the second debris collection device without supplying air directly to the connection pipe.

While the first debris collection device preferably has a double structure including the inner member and the outer member in preferred embodiments described above, the present invention is not restricted to this. The first debris collection device may alternatively have any structure as long as the non-minute debris is removed, and the minute debris flows into the second debris collection device.

While the underwater bubble outlet is preferably located below the lower end of the first debris collection device in preferred embodiments described above, the present invention is not restricted to this. In the present invention, the underwater bubble outlet may alternatively be located above or at the same height as the lower end of the first debris collection device.

While the underwater bubble outlet is preferably located in the gap between the pair of flanges in preferred embodiments described above, the present invention is not restricted to this. In the present invention, the underwater bubble outlet may alternatively be provided on the housing itself of the second debris collection device, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A marine debris collection device comprising:
a first debris collector to remove non-minute debris contained in debris floating on water by allowing the debris to flow thereinto together with the water and;
a connection pipe including a first end connected to the first debris collector to drain the water from the first debris collector; and
a second debris collector connected to a second end of the connection pipe to remove minute debris left unremoved by the first debris collector by adsorbing the minute debris onto a microbubble generated when the water flows into the second debris collector from the first debris collector via the connection pipe and floating the minute debris; wherein
the first debris collector includes an opening movable in an upward-downward direction with respect to a surface of the water to allow the water to flow into the first debris collector.

2. The marine debris collection device according to claim 1, wherein the second debris collector includes an underwater bubble outlet to discharge, below the second end of the connection pipe, the microbubble into the water outside the second debris collector.

3. The marine debris collection device according to claim 2, wherein the underwater bubble outlet is located in a vicinity of or adjacent to a lower end of the second debris collector.

4. The marine debris collection device according to claim 3, wherein the underwater bubble outlet is located below a lower end of the first debris collector.

5. The marine debris collection device according to claim 1, wherein the connection pipe includes:
a flow path narrowed portion located in a flow path of the connection pipe to narrow the flow path; and
a first bubble generator connected to a vicinity of the flow path narrowed portion to generate the microbubble by supplying air to the water that flows through the connection pipe.

6. The marine debris collection device according to claim 5, wherein the second debris collector includes a second bubble generator to generate the microbubble by providing an annular flow path in a plan view and generating swirling flows.

7. The marine debris collection device according to claim 6, wherein the second bubble generator includes the second end of the connection pipe connected to the second debris collector at a location deviated from a center position of the second debris collector in a right-left direction to allow the water to flow along the annular flow path inside the second debris collector.

8. The marine debris collection device according to claim 6, wherein the second bubble generator includes a conical portion having a conical shape that tapers upward from a vicinity of a lower end of the second debris collector.

9. The marine debris collection device according to claim 8, wherein the second end of the connection pipe is provided at a height that overlaps the conical portion in the upward-downward direction.

10. The marine debris collection device according to claim 5, wherein the flow path narrowed portion includes a protrusion that protrudes into the flow path to narrow the flow path.

11. The marine debris collection device according to claim 10, wherein the protrusion includes a curved surface that protrudes toward the first debris collector.

12. The marine debris collection device according to claim 11, wherein
the protrusion has an arcuate shape including the curved surface; and
the first bubble generator includes an end located in a vicinity of or adjacent to the protrusion and on an inner peripheral side of the protrusion in a plan view.

13. The marine debris collection device according to claim 1, further comprising:
a submerged pump to generate a flow of the water that flows into the first debris collector and a flow of the water that flows into the second debris collector via the connection pipe.

14. The marine debris collection device according to claim 13, wherein the submerged pump is located in the first debris collector.

15. The marine debris collection device according to claim 13, wherein
the first debris collector includes:
a cylindrical inner member including the opening at an upper end thereof to allow the water to flow into the cylindrical inner member, the cylindrical inner member having buoyancy so as to float; and
an outer member maintained at a predetermined height with respect to the water surface, the outer member housing the submerged pump and the cylindrical inner member; and
the cylindrical inner member descends in the water such that the opening moves below the water surface when the submerged pump is driven, and ascends in the water such that the opening moves above the water surface when the submerged pump is stopped.

16. The marine debris collection device according to claim 15, wherein the cylindrical inner member has the buoyancy due to an air reservoir integral and unitary with the cylindrical inner member, or due to a float separate from the cylindrical inner member.

17. The marine debris collection device according to claim 2, wherein the first debris collector allows the microbubble and the minute debris discharged via the underwater bubble outlet to flow thereinto together with water again.

18. The marine debris collection device according to claim 1, wherein
the second debris collector includes a discharge pipe at an upper end thereof to discharge a floated microbubble onto which the minute debris has been adsorbed to the water surface; and
the marine debris collection device further comprises a reservoir to store the microbubble discharged via the discharge pipe together with the minute debris.

19. The marine debris collection device according to claim 18, wherein the reservoir includes a defoaming agent to eliminate the microbubble stored in the reservoir.

20. The marine debris collection device according to claim 1, further comprising:
a bracket to fix the first debris collector and the second debris collector to a floating pier that floats on the water surface.
